(19) United States
(12) Patent Application Publication
(10) Pub. No.: US 2018/0304840 A1
(43) Pub. Date: Oct. 25, 2018

(54) Automobile Bumper Structure

(71) Applicants: Compagnie Plastic Omnium, Lyon (FR); Yanfeng Plastic Omnium Automotive Exterior Systems Co., Ltd., Shanghai (CN)

(72) Inventor: Ya Cheng, Shanghai (CN)

(21) Appl. No.: 15/768,739

(22) PCT Filed: Aug. 10, 2016
(86) PCT No.: PCT/CN2016/094331

§ 371 Date: Apr. 16, 2018

(30) Foreign Application Priority Data
Oct. 16, 2015 (CN) 201520799333.5

(51) Int. Cl. B60R 19/24; B60R 19/18

(52) U.S. Cl. CPC B60R 19/24; B60R 2019/245; B60R 2019/1886; B60R 19/18

(57) ABSTRACT

The present invention relates to an automobile bumper structure including a bumper body and a bumper skirt provided in the lower part of the bumper body, the lower end of the bumper body inwardly recessing so as to form a retreat portion arranged transversely along the bumper body, the retreat portion having an upper sidewall, a concave surface and a lower sidewall for supporting the bumper skirt, wherein an upper edge of the bumper skirt is folded so as to form a platform, the platform being provided at its front end with a boss for cooperating with the upper sidewall of the retreat portion.

### FIELD OF THE INVENTION

The present invention relates to the field of automobile parts, and more particularly to an automobile bumper structure.

### BACKGROUND OF THE INVENTION

An automobile bumper typically comprises a bumper body arranged in the front or rear portion of an automobile for preventing the automobile from damage in collision so as to protect the automobile and the safety of the people therein. To further improve the safety performance and the quality of the automobile, the bumper body has various parts assembled thereon. If the assembling between the bumper body and the part(s) is not so reliable or the gap therebetween is too big, it will severely affect the quality of the automobile, even its safety performance.

It is known from prior art that an automobile bumper structure typically comprises a bumper body and a bumper skirt connected to the former. Customers often observe a light leak between the bumper body and the skirt due to the big gap between these two parts. Such a light leak would impact the esthetical appearance of an automobile, reducing customers' desire to buy the automobile.

### SUMMARY OF THE INVENTION

The object of the present invention is to eliminate the light leak between the bumper body and the bumper skirt of an automobile so as to improve its esthetical appearance.

To this end, the present invention provides an automobile bumper structure, comprising a bumper body and a bumper skirt provided in a lower part of the bumper body, a lower end of the bumper body inwardly recessing so as to form a retreat portion arranged transversely along the bumper body, the retreat portion having an upper sidewall, a concave surface and a lower sidewall for supporting the bumper skirt, wherein an upper edge of the bumper skirt is folded so as to form a platform, the platform being provided at its front end with a boss for cooperating with the upper sidewall of the retreat portion.

Since the lower sidewall of the retreat portion and the boss enable the bumper body and the bumper skirt to match each other with no gap in a vertical direction, light leak between these two parts is eliminated. Meanwhile, it enhances the matching accuracy and makes the entire structure more stable and the connection more robust.

The automobile bumper structure can further comprise one or more following features, taken alone or together:
The concave surface is provided with one or more snapping orifices distributed in a length direction of the retreat portion, and the platform is provided at its distal end with a snapping structure for cooperating with the snapping orifices. This allows to assemble the bumper skirt easily into the bumper body by a simple snapping.
The snapping structure for cooperating with the snapping orifices comprises an upper snapping element arranged on an upper side of the platform and a lower snapping element arranged on a lower side of the platform. This allows the snapping structure to cooperate with the snapping orifices more closely.
The upper snapping element is configured to be in the form of a protuberance and the lower snapping element is configured to be an elastic element. This makes the assembling easier and makes it difficult for the snapping structure to be disengaged from the snapping orifice during a driving of the automobile, which renders the entire structure more stable and makes the quality of the automobile improved.
The protuberance has a section of triangle shape. Of course, it can be of other shapes.
The boss is of prismatic shape. Of course, it can be of other shapes.
The retreat portion is configured such that the distance between the upper sidewall and the lower sidewall in the vertical direction reduces progressively from the outside to the inside of the automobile, in order to facilitate the assembly of the platform in the retreat portion.
The boss is situated on the platform backwardly relative to an outside surface of the bumper skirt. This allows to avoid contact wear in a visible part of the bumper skirt.
In one embodiment, one end of the lower snapping element is connected with the platform and the other end thereof extends slantingly downwards towards the front end of the platform. In another embodiment, the lower snapping element comprises a first section extending downwards in a direction perpendicular to the platform and a second section extending slantingly upwards towards the distal end of the platform, the platform being provided with an aperture for cooperating with the lower snapping element.
Preferably, the lower snapping element is arranged correspondingly under the upper snapping element. This makes it more difficult for the snapping structure to be disengaged from the snapping orifice during a driving of the automobile.
The lower sidewall of the retreat portion is folded downwards so as to form a position-limiting portion for cooperating with the bumper skirt. The position-limiting portion 102 limits the position of the bumper skirt and supports the same, which renders the entire structure more stable.
The position-limiting portion is provided with one or more position-limiting blocks, preferably uniformly distributed on the position-limiting portion. This allows to improve the matching accuracy.
The boss is made of a soft plastic material. As a result, the boss will not scratch the bumper body during the assembling and can abut against the bumper body sufficiently.

The terms of direction “lower”, “upper” are mentioned in a normal use position of the bumper structure.

The term “front end” is understood to mean the end close to an observer facing the bumper structure. The term “distal end” is understood to mean the end far away from an observer facing the bumper structure.

### BRIEF DESCRIPTION OF THE DRAWINGS

FIG. 1 is a schematic structural view of an embodiment of the present invention;

FIG. 2 is a schematic partial structural view of an embodiment of the present invention; and

FIG. 3 is a schematic partial structural view of another embodiment of the present invention.

In the drawings, the reference numeral 1 refers to a bumper body (101 a retreat portion (101a an upper sidewall, 101b a concave surface, 101c a lower sidewall), 102 a position-limiting portion (102a position-limiting blocks)), and 2 a bumper skirt (201 a platform, 202 a prismatic boss, 203 an upper snapping element, 204 a lower snapping element (204a a first section, 204b a second section).

### DETAILED DESCRIPTION OF THE EMBODIMENTS

The present invention will be further explained in detail based on the embodiments with reference to the drawings.

In FIGS. 2 and 3, the front end of the platform 201 is at the right side of the drawings, the distal end of the platform 201 is at the left side of the drawings, the upper side of the platform 201 is at the top of the drawings, and the lower side of the platform 201 is at the bottom of the drawings.

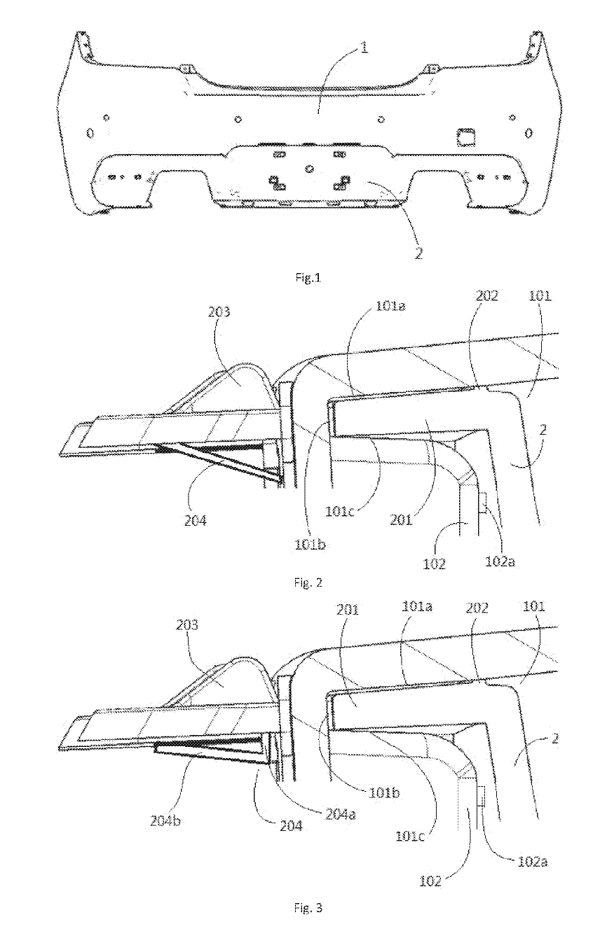

With reference to FIGS. 1 to 3, an automobile bumper structure according to an embodiment comprises a bumper body 1 and a bumper skirt 2 provided in the lower part of the bumper body 1, the lower end of the bumper body 1 inwardly recessing so as to form a retreat portion 101 arranged transversely along the bumper body, the retreat portion 101 having an upper sidewall 101a, a concave surface 101b and a lower sidewall 101c for supporting the bumper skirt 2. The upper edge of the bumper skirt 2 is folded so as to form a platform 201, the platform 201 being provided at its front end with a boss 202 for cooperating with the upper sidewall 101a of the retreat portion. Since the lower sidewall 101c of the retreat portion 101 and the boss 202 enable the bumper body 1 and the bumper skirt 2 to match each other with no gap in a vertical direction, light leak between these two parts is eliminated. Meanwhile, it enhances the matching accuracy and makes the entire structure more stable and the connection more robust.

In this embodiment, the concave surface 101b is provided with a plurality of snapping orifices uniformly distributed in the length direction of the retreat portion 101 and the platform 201 is provided at its distal end with a snapping structure for cooperating with the snapping orifices. The snapping structure comprises an upper snapping element 203 arranged on the upper side of the platform 201 and a lower snapping element 204 arranged on the lower side of the platform 201. In a preferable example, the upper snapping element 203 is configured to be in the form of a protuberance with triangle shaped section and the lower snapping element 204 is configured to be an elastic element. It will be appreciated that the upper snapping element 203 may take other form.

Preferably, the lower snapping element 204 is arranged correspondingly under the upper snapping element 203.

In an illustrative example, the boss 202 is of prismatic shape. Preferably, the boss 202 is made of a soft plastic material.

Preferably, the lower sidewall 101b of the retreat portion is folded downwards so as to form a position-limiting portion 102 for cooperating with the bumper skirt 2.

Preferably, the position-limiting portion 102 is provided with a plurality of position-limiting blocks 102a uniformly distributed.

With reference to FIG. 2, in an embodiment, one end of the lower snapping element 204 is connected with the platform 201 and the other end thereof extends slantingly downwards towards the front end of the platform 201.

With reference to FIG. 3, in another embodiment, the lower snapping element 204 comprises a first section 204a extending downwards in a direction perpendicular to the platform 201 and a second section 204b extending slantingly upwards towards the distal end of the platform 201, the platform 201 being provided with an aperture for cooperating with the lower snapping element 204.

As shown in FIGS. 2 and 3, the retreat portion 101 is configured such that the distance between the upper sidewall 101a and the lower sidewall 101c in the vertical direction reduces progressively from the outside (right in the figures) to the inside (left in the figures) of the automobile, in order to facilitate the assembly of the platform 201 in the retreat portion 101. In fact, such a flared shape allows to easily receive the platform of the bumper skirt and guide the same in the retreat portion.

As best seen in FIGS. 2 and 3, the boss 202 is situated on the platform backwardly relative to an outside surface of the bumper skirt 2. This allows to avoid contact wear in a visible part of the bumper skirt.

The above contents are detailed explanation to the present invention made on the basis of particular embodiments, and it should not be deemed that the embodiments of the present invention are limited thereto. Without departing from the concepts of the present invention, those ordinarily skilled in the art to which the present invention pertains may make various simple variations or replacements, which should be regarded as falling within the protection scope of the present invention.

1. An automobile bumper structure, comprising a bumper body (1) and a bumper skirt (2) provided in a lower part of the bumper body (1), a lower end of the bumper body inwardly recessing so as to form a retreat portion (101) arranged transversely along the bumper body (1), the retreat portion (101) having an upper sidewall (101a), a concave surface (101b) and a lower sidewall (101c) for supporting the bumper skirt (2), wherein an upper edge of the bumper skirt is folded so as to form a platform (201), the platform being provided at its front end with a boss (202) for cooperating with the upper sidewall (101a) of the retreat portion (101), wherein the concave surface (101b) is provided with one or more snapping orifices distributed in a length direction of the retreat portion (101), and the platform (201) is provided at its distal end with a snapping structure for cooperating with the snapping orifices and wherein the snapping structure for cooperating with the snapping orifices comprises an upper snapping element (203) arranged on an upper side of the platform and a lower snapping element (204) arranged on a lower side of the platform.

2. (canceled)

3. (canceled)

4. The automobile bumper structure according to claim 1, wherein the upper snapping element is configured to be in the form of a protuberance and the lower snapping element is configured to be an elastic element.

5. The automobile bumper structure according to claim 1, wherein the protuberance has a section of triangle shape.

6. The automobile bumper structure according to claim 1, wherein the boss (202) is of prismatic shape.

7. The automobile bumper structure according to claim 1, wherein the retreat portion is configured such that the distance between the upper sidewall and the lower sidewall in the vertical direction reduces progressively from the outside to the inside of the automobile, in order to facilitate the assembly of the platform in the retreat portion.

8. The automobile bumper structure according to claim 1, wherein the boss is situated on the platform backwardly relative to an outside surface of the bumper skirt.

9. The automobile bumper structure according to claim 4, wherein one end of the lower snapping element is connected with the platform and the other end thereof extends slantingly downwards towards the front end of the platform.

10. The automobile bumper structure according to claim 4, wherein the lower snapping element comprises a first section extending downwards in a direction perpendicular to the platform and a second section extending slantingly upwards towards the distal end of the platform, the platform being provided with an aperture for cooperating with the lower snapping element.

11. The automobile bumper structure according to claim 4, wherein the lower snapping element is arranged correspondingly under the upper snapping element.

12. The automobile bumper structure according to claim 1, wherein the lower sidewall of the retreat portion is folded downwards so as to form a position-limiting portion for cooperating with the bumper skirt.

13. The automobile bumper structure according to claim 1, wherein the position-limiting portion is provided with one or more position-limiting blocks, preferably uniformly distributed on the position-limiting portion.

14. The automobile bumper structure according to claim 1, wherein the boss is made of a soft plastic material.
